(19) United States
(12) Patent Application Publication
(10) Pub. No.: US 2016/0047664 A1
(43) Pub. Date: Feb. 18, 2016

(54) ROUTE RETRIEVAL DEVICE AND ROUTE RETRIEVAL SYSTEM

(71) Applicants: Junichi NISHIDA, Toyota-shi, Aichi-ken (JP); TOYOTA JIDOSHA KABUSHIKI KAISHA, Toyota-shi, Aichi-ken (JP)

(72) Inventor: Junichi NISHIDA, Miyoshi-shi (JP)

(73) Assignee: TOYOTA JIDOSHA KABUSHIKI KAISHA, Toyota-shi, Aichi-ken (JP)

(21) Appl. No.: 14/779,087

(22) PCT Filed: Mar. 11, 2014
(86) PCT No.: PCT/IB2014/000286

§ 371 Date: Sep. 22, 2015

(30) Foreign Application Priority Data
Mar. 22, 2013 (JP) 2013-061008

(51) Int. Cl. G01C 21/34; G01C 21/28

(52) U.S. Cl. CPC G01C 21/3469; G01C 21/28

(57) ABSTRACT

A route retrieval device stores fuel efficiency information included in probe information acquired by a plurality of probe vehicles as fuel efficiency information associated with a given segment and a predetermined time unit in the segment which are related to each other. The route retrieval device retrieves a recommended route extending from a departure place to a destination and including the segment on the basis of the associated fuel efficiency information.

### BACKGROUND OF THE INVENTION

1. Field of the Invention

This invention relates to a technique which retrieves a recommended route.

2. Description of Related Art

For the driver of a vehicle, not only driving from a departure place to a destination in a short time, but also improving a fuel efficiency during the drive therebetween is of important concern. There is a car navigation device which performs, when, retrieving a route from a departure place to a destination, route retrieval with a lower fuel cost and shows a route with a minimum fuel cost as a recommended route.

For example, Japanese Patent Application Publication No. 2011-237306 (JP 2011-237306 A) discloses a technique which calculates a fuel cost in each segment on the basis of road information included in map data and corrects the fuel cost using slope information in the map data to retrieve a segment with a minimum fuel cost. In addition, a technique is disclosed which corrects the slope information mentioned above on the basis of segment-by-segment fuel efficiency information (average fuel efficiency in each segment) specified on the basis of probe information and then retrieves a segment with a minimum fuel efficiency cost.

However, when the fuel cost is calculated using the route information and the slope information in the map data, such a problem arises that a real road situation is not reflected. In addition, even when the correction is made in consideration of the road situation using the fuel efficiency information included in the probe information, a situation may be encountered in which information on the same vehicle type as that of a target vehicle for which route retrieval is performed cannot be obtained as the probe information. Even when probe information of the same vehicle type as that of the target vehicle for which route retrieval is performed can be used as the probe information, an average fuel efficiency differs depending on the grades of engines, equipment, or the like despite the same vehicle type. As a result, a situation may be encountered in which a proper correction is not made. Additionally, a situation may be encountered in which the segment-by-segment fuel efficiency information is insufficient to be able to respond to a change in fuel efficiency within a segment and a proper correction is not made.

As a result, there may be a case where the route shown as the recommended route is not actually the route with the minimum fuel cost.

### SUMMARY OF THE INVENTION

This invention provides a route retrieval device capable of retrieving a route with a higher fuel efficiency in a real driving situation and the like.

In an aspect of this invention, the route retrieval device includes a storage portion, and a main control portion, stores fuel efficiency information included in probe information acquired by a plurality of probe vehicles as fuel efficiency information associated with a given segment and a predetermined time unit in the segment which are related to each other, and retrieves a recommended route extending from a departure place to a destination and including the foregoing segment on the basis of the associated fuel efficiency information.

According to the aspect of this invention, it is possible to provide the route retrieval device capable of retrieving a route with a higher fuel efficiency in a real driving situation and the like.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall schematic diagram showing an in-vehicle terminal, an information center, probe vehicles, and a route retrieval system according to first and second embodiments;

FIG. 2 shows a flow chart of the collection and transmission of probe information by the in-vehicle terminal in the probe vehicle according to the first and second embodiments;

FIG. 3A shows an example of a flow chart of recommended route retrieval according to the first and second embodiments;

FIG. 3B shows an example of a flow chart of the recommended route retrieval according to the first and second embodiments;

FIG. 3C shows an example of a flow chart of the recommended route retrieval according to the first and second embodiments;

FIG. 4 shows an example of route guidance display on the display portion of the in-vehicle terminal which shows the result (recommended route) of the route retrieval according to the first and second embodiments;

FIG. 5A shows an example (Case 1 and Case 2) of the recommended route retrieval according to the first and second embodiments;

FIG. 5B shows an example (Case 1) of the recommended route retrieval according to the first and second embodiments;

FIG. 5C shows an example (Case 2) of the recommended route retrieval according to the first and second embodiments; and

FIG. 6 is a flow chart of the production of recommended route information performed by the information center of the route retrieval system according to the second embodiment.

### DETAILED DESCRIPTION OF EMBODIMENTS

Referring to the drawings, embodiments for carrying out this invention will be described below.

### First Embodiment

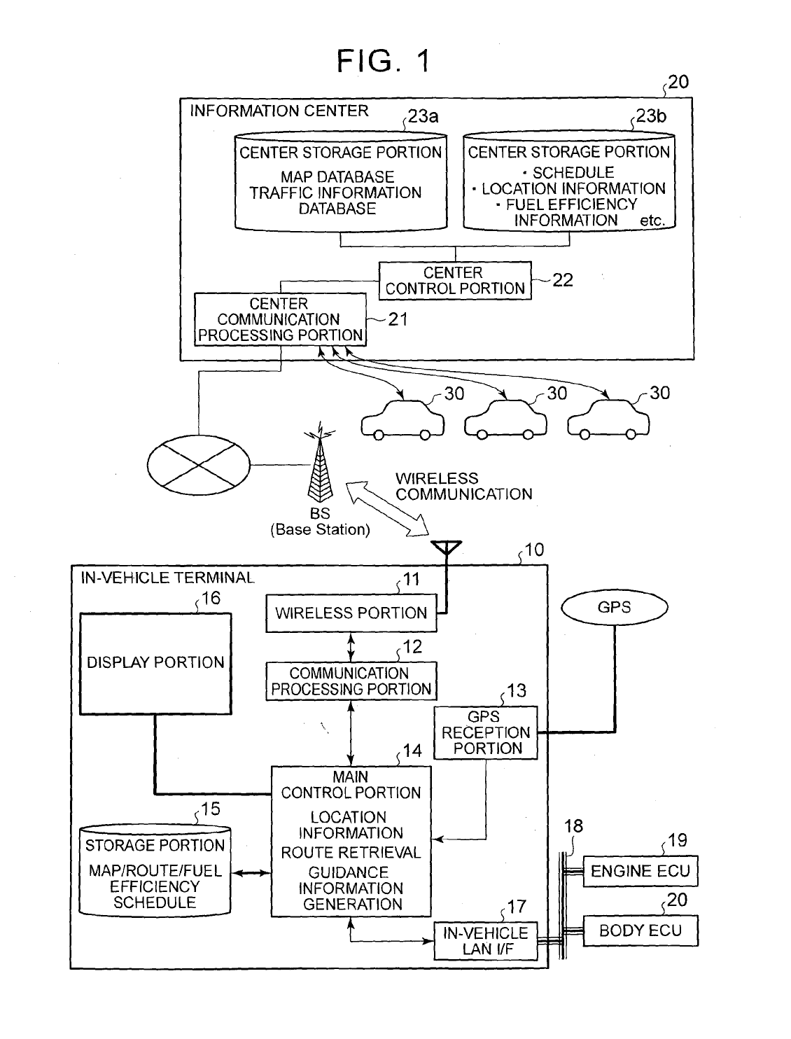

FIG. 1 is an overall schematic diagram showing an in-vehicle terminal 10, an information center 20, probe vehicles 30, and a route retrieval system 1 each according to this embodiment.

The route retrieval system 1 includes the in-vehicle terminal 10, the information center 20, and the large number of probe vehicles 30. Note that, in this embodiment, a description will be given of the case where a vehicle in which the in-vehicle terminal 10 is mounted is also the probe vehicle 30.

The in-vehicle terminal 10 has the function of a route retrieval device and includes a wireless portion11, a communication processing portion12, a global position system (GPS) reception portion13, a main control portion14, a storage portion15, a display portion16, an in-vehicle local area network (LAN) interface 17, and the like.

The wireless portion11 is equipment for communicating with the outside via a wireless network such as a mobile phone network. Examples of the wireless portion11 includes a data communication module (DCM), a mobile phone terminal connected either wiredly or wirelessly to the in-vehicle terminal 10, and the like. In this embodiment, the wireless portion11 communicates with the information center 20 via a wireless network, a base station, or the like to transmit information from the in-vehicle terminal 10 to the information center 20 or receives information transmitted from the information center 20 at the in-vehicle terminal 10.

The communication processing portion12 performs conversion of a reception signal from the information center 20 received via the wireless portion11 to a signal usable in the main control portion14, conversion of a signal output from the main control portion14 to a signal to be transmitted to the information center 20 via the wireless portion11, and the like.

The GPS reception portion 13 receives signals from several (e.g., four) GPS satellites provided overhead, calculates the location (longitude/latitude) of the vehicle in which the in-vehicle terminal 10 is mounted, and outputs the location to the main control portion14.

The main control portion14 is an information processing terminal including a central processing unit (CPU), a random access memory (RAM), a read only memory (ROM), an input/output portion, and the like. The CPU performs various processes in accordance with programs stored in the ROM. For example, the CPU performs a route retrieval process on the basis of the location information of the vehicle input from the GPS reception portion13 and map data, probe information, or the like stored in the storage portion15. The CPU also performs the process of generating route guidance information for guiding the vehicle from a departure place to a destination on the basis of the retrieved route and outputs the generated route guidance information as an image signal to the display portion16. Additionally, the CPU performs a process for storing in the storage portion15 the probe information and the like transmitted from the information center 20 and input via the wireless portion11 and the communication processing portion12. Further, the CPU performs the process of generating the probe information under predetermined conditions from the location information of the vehicle input from the GPS reception portion13, the fuel efficiency information of the vehicle input via the in-vehicle LAN interface 17, and the like and outputs, to the communication processing portion12, the probe information to be transmitted to the center device 20. It may also be possible that the probe information is generated in a device other than the in-vehicle terminal 10 serving as the route retrieval device and the device is configured to perform transmission of the probe information to the information center 20 or the like.

Note that the probe information is information generated on the basis of data acquired with a sensor mounted in the probe vehicle 30 or the like when the probe vehicle 30 has actually moved (including a state where the probe vehicle 30 has been parked in an ignition (IG)-on state). Main information items included in the probe information are the location information of the probe vehicle, vehicle speed information, fuel efficiency information, and the like, but jam information generated by combining the vehicle speed information with the location information or the like is also included in the probe information. The probe information is not limited to information related to a driving situation and a road situation. For example, weather information generated on the basis of data from the raindrop sensor of a wiper mounted in the probe vehicle and the like are also included in the probe information.

The storage portion15 is a nonvolatile storage device or the like and stores the map information and the like. Note that the map information includes the position information of a link, the road type (express highway, general road, narrow street, etc.) information of the link, the position information of a node, the type information of the node, information on a node-link connection relationship, and the like. The storage portion15 also stores the probe information and route information each transmitted from the information center 20 and received by the wireless portion11 and the like. Note that, by transmitting a signal requesting the probe information generated in the main control portion14 to the information center 20 via the communication processing portion12 and the wireless portion11 the probe information is transmitted from the information center 20 in response to the request. The request may be either periodically made or arbitrarily made as an instruction from a user or the like.

The storage portion15 stores the fuel efficiency information included in the probe information as fuel efficiency information associated with a predetermined segment and a time unit within the segment which are related to each other. Specifically, the storage portion15 stores an average fuel efficiency in each predetermined time (e.g., 1-minute average fuel efficiency) within the predetermined segment. Note that the predetermined segment is a segment in which the probe information including the average fuel efficiency in each predetermined time is acquired. As will be described later, the predetermined segment is set for each of the probe vehicles 30 as a segment in which the probe information including the average fuel efficiency in each predetermined time is acquired by a center control portion22 of the information center 20.

The display portion16 has a liquid crystal display, or the like and displays an image in accordance with the image signal, such as the route guidance information, input from the main control portion14. The in-vehicle terminal 10 provides route guidance from the departure place to the destination to a user using route guidance display displayed on the display portion16. In addition to this, in combination with the route guidance display on the display portion16, audio route guidance can also be provided via a speaker (not shown). In this case, an audio signal for the route guidance is generated by the main control portion14 and input to the speaker.

The in-vehicle LAN interface 17 is an interface for connection to the in-vehicle LAN 18. Note that, to the in-vehicle LAN, various electronic control units (ECUs) such as an engine ECU 19 and a body ECU 20 are connected to allow the main control portion14 to receive information signals representing, e.g., the vehicle speed/fuel efficiency information and the like from such ECUs and the like via the in-vehicle LAN 18.

The information center 20 includes a center communication processing portion21, the center control portion22, center storage portions 23a and 23b, and the like. The information center 20 provides the service of providing traffic information such as jam information, traffic information, or regulation information generated by the center control portion22 on the basis of a database of the map information, the traffic information, or the like in the center storage portion23a, traffic information acquired in real time from the outside, or the like. Also, the information center 20 receives, from the probe vehicles 30, the probe information including the various information items acquired by the large number of probe vehicles 30, produces the database in the center storage portion23b, and provides the service of distributing information in response to a request from the vehicle or the like. The probe information collected by the information center 20 in this embodiment includes the average fuel efficiency in each predetermined time (e.g., per minute) within the segment acquired by each of the probe vehicles 30.

The center communication processing portion21 performs conversion of the information received from the in-vehicle terminal 10 via a wireless network or the like to a signal usable in the center control portion22, conversion of a signal output from the center control portion22 to a signal to be transmitted to the in-vehicle terminal 10 via a wireless network, and the like.

As described above, the center control portion22 generates the traffic information such as the jam information, the traffic information, or the regulation information on the basis of data such as the map information or the traffic information stored in the center storage portion23a or the like, the traffic information acquired from the outside, or the like and outputs the generated traffic information to the center communication processing portion21 so as to transmit the traffic information to the vehicle or the like. Also, the center control portion 22 performs a process for additionally storing the probe information transmitted from the probe vehicle 30 and input via the center communication processing portion 21, the traffic information received from the outside and input via the center communication processing portion 21, or the like in the database stored in the center storage portion 23a or 23b. Further, the center control portion 22 generates a setting signal for setting, for each of the probe vehicles 30, various conditions (predetermined segment in which the probe information is acquired, information to be acquired, etc.) under which the probe vehicle 30 acquires the probe information and transmits the probe information to the information center 20 and transmits the setting signal to the probe vehicle 30 via the center communication processing portion 21.

The center storage portion 23a stores the map information, the traffic information, and the like and the database of such information is constructed therein. The center storage portion 23b stores the probe information, and a database of the probe information is constructed therein.

The probe vehicle 30 has the in-vehicle terminal 10 mounted therein and transmits, to the information center 20, the probe information including the various information items acquired with the movement thereof such as, e.g., the fuel efficiency information, the vehicle speed information, and the location information under predetermined conditions. As described above, the setting of the predetermined segment in which the probe vehicle 30 acquires the probe information, the information to be acquired, and the like is performed with the setting signal transmitted from the information center 20 (center control portion 22).

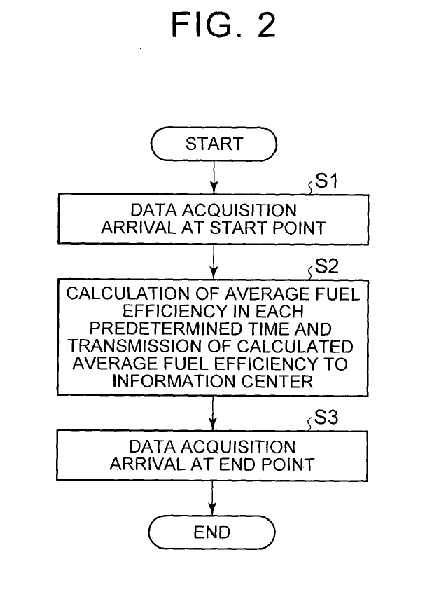

Next, the process in which the probe vehicle 30 moves, acquires the probe information, especially the average fuel efficiency in each predetermined time within the segment, and transmits the acquired information to the information center will be described using the flow chart of FIG. 2. Note that, in this embodiment, a description will be given of the case where the vehicle in which the in-vehicle terminal 10 is mounted is also the probe vehicle 30.

When it is determined in Step S1 that the vehicle 30 has arrived at the start point of a predetermined segment on the basis of the map information in the storage portion 15 and the location information of the vehicle from the GPS reception portion 13 or the like, the average fuel efficiency in each predetermined time is calculated and transmitted to the information center 20 in Step S2. The average fuel efficiency in each predetermined time is calculated and transmitted to the information center 20 till the probe vehicle 30 arrives at the end point of the segment. Note that the predetermined segment indicates a segment specified in advance as a segment in which the probe information. especially the average fuel efficiency in each predetermined time is acquired by the setting signal from the information center 20.

Then, when it is determined in Step S3 that the probe vehicle 30 has arrived at the end point of the segment on the basis of the map information in the storage portion 15 and the location information of the vehicle from the GPS reception portion 13, the acquisition of the average fuel efficiency in the segment and the transmission thereof to the information center 20 are ended.

Every time the probe vehicle 30 moves across the segment set in advance as the segment in which the probe information is to be acquired with the setting signal from the information center 20, the average fuel efficiency in each predetermined time is acquired and transmitted to the information center 20 in accordance with this flow. Note that, together with the average fuel efficiency within the segment, information including the time at which the average fuel efficiency was acquired, e.g., a date, an hour of the day, or the like is also simultaneously transmitted and stored as the probe information in the center storage portion 23b of the center device 20.

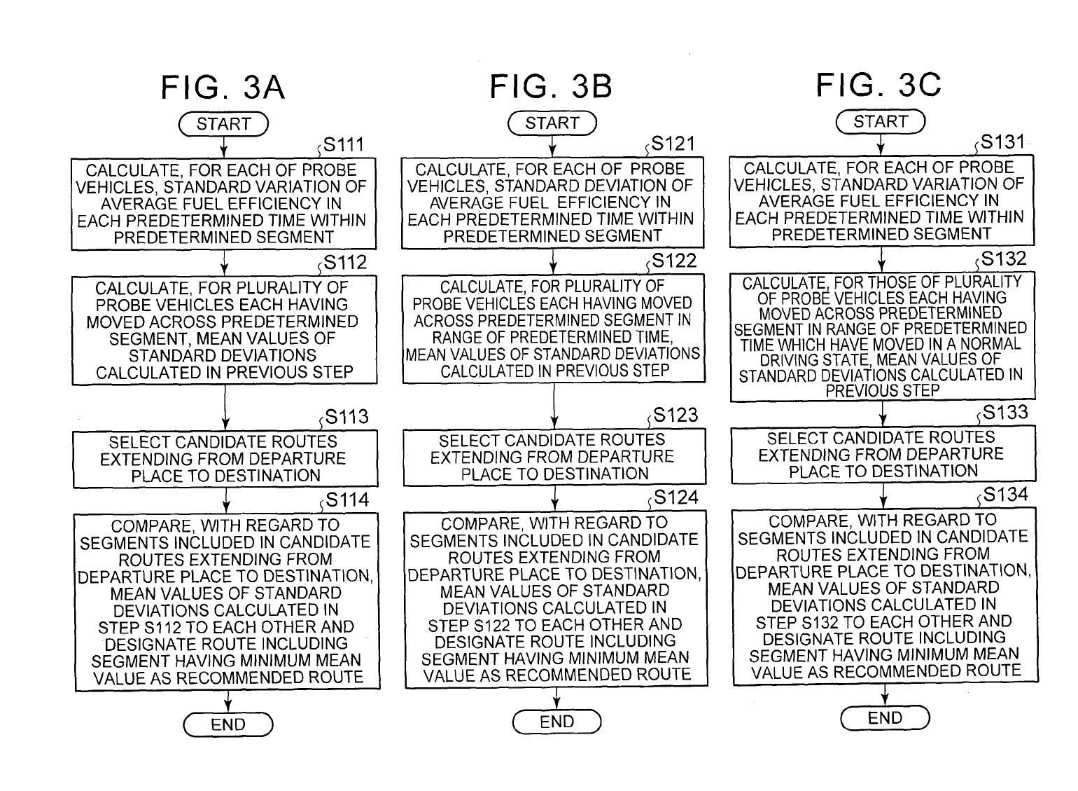

Next, using the flow charts of FIGS. 3A to 3C, a description will be given of a route retrieval process performed by the main control portion 14 of the in-vehicle terminal 10, especially a fuel efficiency consideration process in which the fuel efficiency information is considered. Specifically, the description will be given of three examples of the route retrieval process in FIGS. 3A to 3C.

FIG. 3A shows the first example of the route retrieval process performed by the main control portion 14 of the in-vehicle terminal 10.

First, in Step S111, for each of the probe vehicles 30, the standard deviation of the average fuel efficiency in each predetermined time within the predetermined segment is calculated.

Next, in Steps S112, the mean values of the standard deviations calculated in Step S111 are calculated for the plurality probe vehicles 30 having moved across the predetermined segments.

Next, in Step S113, a plurality of candidate routes are retrieved and selected for the departure place and the destination each set by the user on the basis of the map information, the traffic information, or the like stored in the storage portion 15. Note that, on the basis of the traffic information or the like, a route which is not travelable or the like due to construction work, a traffic accident, or the like can be excluded.

Next, in Step S114, with regard to the respective segments included in the candidate routes selected in Step S113, the mean values of the standard deviations calculated in Step S112 are compared to each other and the route including the segment having the minimum mean value is designated as the recommended route. Note that, in this example of the route retrieval process, the route having the minimum mean value is designated as the recommended route, but it may also be possible to add the route having the second minimum mean value to the route having the minimum mean value and collectively designate the plurality of routes as the recommended routes. Also, Steps S111 and S112 and Step S113 may also be performed in parallel.

In this example of the route retrieval process, in Step S111, the standard deviation in each predetermined time within the predetermined segment is calculated for each of the probe vehicles 30 and used as an index of the route retrieval. This allows variations in average fuel efficiency in each predetermined time within the predetermined segment to be evaluated for each of the probe vehicles. Therefore, it can be considered that, as the variations are smaller, the frequency of the operation of changing an accelerator opening is lower and fuel efficiency is higher and, by designating the segment having the smaller mean value of the standard deviation of the probe vehicle 30 having moved as the recommended route, the recommended route having higher fuel efficiency can be provided.

In addition, not the average fuel efficiency per segment, but the standard deviation of the average fuel efficiency in each predetermined time within the segment is used as the index of the route retrieval. This allows a recommended route with high accuracy based on a road situation such as the slope of a road, the up-and-down profile thereof, the degree of a jam, or a weather to be retrieved without depending on the individual elements of the plurality of probe vehicles 30 having moved down the candidate routes which are selected in Step S113, such as the vehicle types, the grades of the engines, and the equipment. That is, when the recommended routes are retrieved on the basis of the average fuel efficiency in each segment, if the vehicle types of the probe vehicles 30 having moved across the respective segments included in the candidate routes are different, it follows that fuel efficiency performance differs depending on the vehicle type or the like. As a result, due to the vehicle types of the probe vehicles 30 or the like, a problem may arise in route retrieval. However, when the recommended route is retrieved on the basis of the standard deviation, a recommended route with high accuracy can be retrieved irrespective of the vehicle types of the probe vehicles 30 since the standard deviation is an index which does not depend on the vehicle types of the probe vehicles 30 or the like.

Next, FIG. 3B shows the second example of the route retrieval process performed by the main control portion 14 of the in-vehicle terminal 10.

In this example of the route retrieval process, Step S112 of the first example of the route retrieval process is modified, while the other steps are the same as in the first example of the route retrieval process.

First, in Step S121, in the same manner as in the first example of the route retrieval process, the standard deviation of the average fuel efficiency in each predetermined time within a predetermined segment is calculated for each of the probe vehicles 30.

Next, in Step S122, the mean values of the standard deviations calculated in Step S121 are calculated for the plurality of probe vehicles 30 each having moved across the predetermined segment in the range of the predetermined time. Note that examples of the range of the predetermined time include a range of 30 minutes immediately before the route retrieval is performed, a specific day of the week, a specific hour of the day, and the like.

Next, in Step S123, in the same manner as in the first example of the route retrieval process, a plurality of candidate routes are retrieved and selected for a departure place and a destination each set by a user on the basis of the map information, the traffic information, or the like stored in the storage portion 15. Note that this example of the route retrievable process is the same as the first example of the route retrieval process in that the route which is not travelable or the like due to construction work, a traffic accident, or the like can also be excluded.

Next, in Step S124, in the same manner as in the first example of the route retrieval process, the mean values of the standard deviations calculated in Step S122 are compared to each other with regard to the segment included in each of the candidate routes selected in Step S123 and the route including the segment having the minimum mean value is designated as the recommended route. Note that this example of the route retrievable process is the same as the first example of the route retrieval process in that it may also be possible to add the route having the second minimum mean value to the route having the minimum mean value and collectively designate the plurality of routes as the recommended route.

In this example of the route retrieval process, unlike in the first example of the route retrieval process, the mean values of the standard deviations of the plurality of probe vehicles 30 each having moved across the predetermined segment in the range of the predetermined time, which have been calculated in Step S121, are calculated in Step S122. As a result, by specifying, e.g., the range of 30 minutes immediately before, it is possible to perform the retrieval of the recommended route based on a real-time road situation and, by specifying a specified day of the week and a specified hour of the date, it is possible to perform the retrieval of the recommended route based on the road situation specific to the day of the week and the hour of the day. In other words, it is possible to provide a recommended route with high accuracy which is more suited to the driving situation.

Next, FIG. 3C shows the third example of the route retrieval process performed by the main control portion 14 of the in-vehicle terminal 10.

In this example of the route retrieval process, Step S112 of the first example of the route retrieval process or Step S122 of the second example of the route retrieval process is modified, while the other steps are the same as in the first and second examples of the route retrieval process.

First, in Step S131, in the same manner as in the first and second examples of the route retrieval process, the standard deviation of the average fuel efficiency in each predetermined time within a predetermined unit is calculated for each of the probe vehicles 30.

Next, in Step S132, the mean values of the standard deviations calculated in Step S131 are calculated for those of the plurality of probe vehicles 30 having moved across the predetermined segment in the range of the predetermined time which have moved in a normal driving state. Note that, in defining the normal driving state, an abnormal driving state is defined, and the normal driving state is defined as a driving state other than the abnormal driving state. Examples of the abnormal driving state include a state where a temporary jam due to an accident occurs within a segment and, because of the jam, low-speed driving is performed, and a case where a vehicle is, in a parked state, in a parking area or service area within the segment. These abnormal driving states can be determined from Vehicle Information Communication System™ (VICS) information or from the jam information, the location information, the vehicle speed information, or the like transmitted from the probe vehicles 30.

Next, in Step S133, in the same manner as in the first and second examples of the route retrieval process, a plurality of candidate routes are retrieved and selected for a departure place and a destination each set by a user on the basis of the map information, the traffic information, or the like stored in the storage portion 15. Note that this example of the route retrieval process is also the same as the first and second examples of the route retrieval process in that a route which is not travelable or the like due to construction work, a traffic accident, or the like can be excluded.

Next, in Step S134, in the same manner as in the first and second examples of the route retrieval process, the mean values of the standard deviations calculated in Step S132 are compared to each other with regard to the segments included in the candidate routes selected in Step S133 and the route including the segment having the minimum mean value is designated as the recommended routes. Note that this example of the route retrievable process is the same as the first and second examples of the route retrieval process in that it may also be possible to add the route having the second minimum mean value to the route having the minimum mean value and collectively designate the plurality of routes as the recommended route.

In this example of the route retrieval process, unlike in the first and second examples of the route retrieval process, the mean value of the standard deviations of those of the plurality of probe vehicles 30 each having moved across the predetermined segment in the range of the predetermined time which have moved in the normal driving state are calculated in Step S132. As a result, it is possible to remove the probe vehicle 30 affected by a jam due to an accident, the probe vehicle 30 that had time to be parked in a parking area, a service area, or the like within the segment, and the like and retrieve s recommended route with higher accuracy.

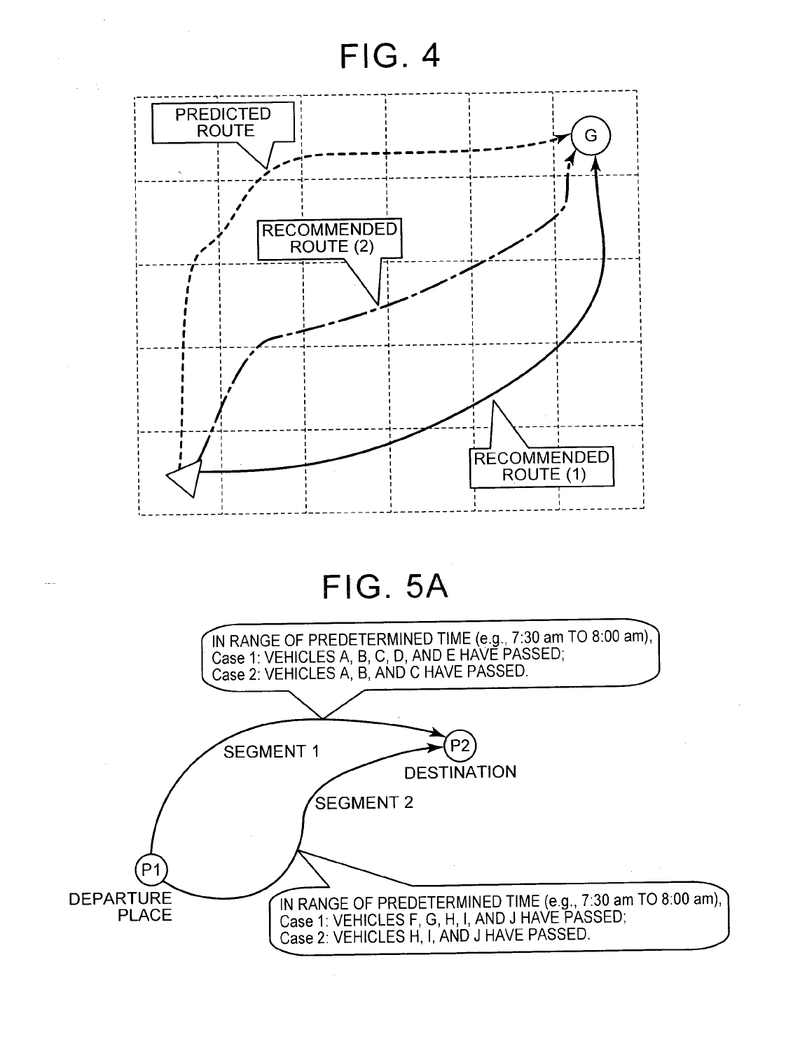

As described above, an image signal representing the recommended route retrieved by the route retrieval process performed by the main control portion 14 is output as the route guidance information to the display portion 16 and displayed on the display portion 16. By displaying the route guidance information, the in-vehicle terminal 10 provides route guidance to the user. FIG. 4 shows an example in which recommended routes are retrieved from among three candidate routes and the result thereof is displayed on the display portion 16. Note that, in this display example, of the plurality of (three) candidate routes, the route having the minimum mean value of the standard deviations calculated in Step S112, S122, or S132 and the route having the second minimum mean value of the standard deviations are displayed as the two recommended routes.

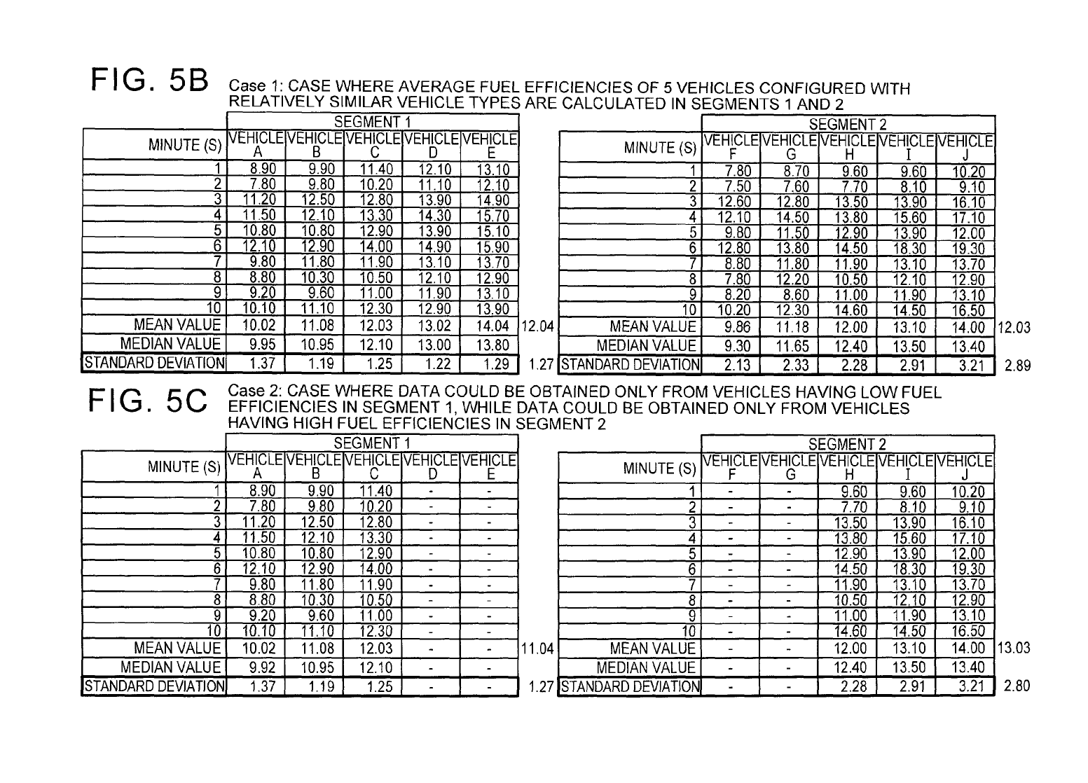

Next, using FIGS. 5A to 5C, a description will be given of an example of retrieval of the recommended routes (hereinafter referred to as the recommended route retrieval example) according to this embodiment.

FIGS. 5A to 5C show an example in which a route retrieval process by the in-vehicle terminal 10 (main control portion 14) in this embodiment is performed. Note that the route retrieval according to the second example of the route retrieval process described above is performed.

Referring to FIG. 5A, in this example, the recommended routes extending from a departure place P1 to a destination P2 are retrieved and there are two candidate routes thereof including a route formed of a segment 1 and a route formed of a segment 2. In this example, the route retrieval process is performed in two cases Case 1 and Case 2. Case 1 represents the case where, in the range of the predetermined time, the five probe vehicles 30A, 30B, 30C, 30D, and 30E have each passed through the segment 1 and the five probe vehicles 30F, 30G, 30H, 30I, and 30J have each passed through the segment 2. Case 2 represents the case where, in the range of the predetermined time, the three probe vehicles 30A, 30B, and 30C have each passed through the segment 1 and the three probe vehicles 30H, 30I, and 30J have each passed through the segment 2.

FIG. 5B relates to Case 1 and shows the in-segment time series of the average fuel efficiency in each predetermined time (which is a 1-minute average fuel efficiency in this example) of each of the probe vehicles 30 having passed through the segments 1 and 2 in the range of the predetermined time. In this example, each of the probe vehicles 30 has passed through the segment 1 or 2 in about 10 minutes and acquired ten 1-minute average fuel efficiencies within the segment. In addition, the standard deviation of the 1-minute average fuel efficiency of each of the probe vehicles 30 is calculated on the basis of the in-segment times series of the 1-minute average fuel efficiency and shown (in the lowermost row of each of the tables). Further, with regard to each of the segments 1 and 2, the mean value of the standard deviations of the probe vehicles 30 each having passed therethrough in the range of the predetermined time is calculated and shown (outside the right end of the lowermost row of each of the tables). Additionally, for the purpose of comparison, the average fuel efficiency in the entire segment of each of the probe vehicles 30 is calculated and shown (in the third row from the bottom of each of the tables) and, for each of the segments 1 and 2, the mean value of the average fuel efficiencies in the entire segment of the probe vehicles 30 each having passed therethrough in the range of the predetermined time is calculated and shown (outside the right end of the third row from the bottom of each of the tables). Note that the unit of the fuel efficiencies in the tables is a distance (km) traveled using 1 liter of a fuel “km/l”.

When the segments 1 and 2 are compared to each other in Case 1, the mean values of the average fuel efficiencies in the entire segments of the probe vehicles 30 having passed therethrough each in the range of the predetermined time are 12.04 km/l in the segment 1 and 12.03 km/l in the segment 2, which are substantially the same. However, the mean values of the standard deviations of the probe vehicles 30 having passed through the segments are 1.27 in the segment 1 and 2.89 in the segment 2. Since the segment 1 has a smaller value, the route retrieval process according to this embodiment designates the route formed of the segment 1 as the recommended value.

Thus, variations in the average fuel efficiency within the segment which cannot be determined with the mean value of the average fuel efficiencies in the entire segment can be evaluated using the standard variation of the time series of the 1-minute fuel efficiency within the segment of each of the probe vehicles 30. It can be considered that, as the variations in the 1-minute average fuel efficiency within the segment are smaller, the frequency of the operation of changing an acceleration opening is lower and the fuel efficiency is higher. Therefore, by designating the segment in which the mean value of the standard variations of the probe vehicles 30 having passed through the segment as the recommended route, a recommended route with a higher fuel efficiency can be provided.

Next, FIG. 5C corresponds to Case 2. Since the configuration of each of the tables is the same as in Case 1, a description thereof is omitted.

When the segments 1 and 2 are compared to each other in Case 2, the mean values of the average fuel efficiencies in the entire segments of the probe vehicles 30 having passed therethrough each in the range of the predetermined time are 11.04 km/l in the segment 1 and 13.03 km/l in the segment 2 so that the segment 2 has a higher fuel efficiency value. This is because the fuel efficiencies of the three vehicles that have passed through the segment 2 have absolute values larger than those of the fuel efficiencies of the three vehicles that have passed through the segment 1. However, the mean values of the standard deviations of the probe vehicles 30 having passed through the segments are 1.27 in the segment 1 and 2.80 in the segment 2. Since the segment 1 has a smaller value, the route retrieval process according to this embodiment designates the route formed of the segment 1 as a recommended route.

When the fuel efficiency performances of the probe vehicles 30 having passed through the segments under comparison are thus greatly different from each other, it is difficult to retrieve a recommended route with a higher fuel efficiency even when the average fuel efficiencies in the entire segments are used. However, by using the standard deviation of the 1-minute average fuel efficiency within the segment of each of the probe vehicles 30, even when the fuel efficiency performances of the probe vehicles 30 having passed through the segments are greatly different from each other, it is possible to retrieve a recommended path with a higher fuel efficiency. That is, by using the standard deviation, it is possible to accurately retrieve a recommended route with a higher fuel efficiency irrespective of the vehicle types of the probe vehicles, the grades of the engines, the equipment, or the like.

Next, a description will be given of the function of the in-vehicle terminal 10 as the route retrieval device according to this embodiment.

In this embodiment, the fuel efficiency information included in the probe information is stored in the storage portion 15 as an average fuel efficiency in each predetermined time within a segment, which is fuel efficiency information associated with a predetermined segment and a predetermined unit time within the segment which are related to each other. On the basis of the stored average fuel efficiency in each predetermined unit time within the segment, a recommended route extending from a departure place to a destination and including a predetermined segment is retrieved.

This results in a plurality of fuel efficiency information items associated in relation to the unit time in each predetermined segment, and route retrieval can be performed on the basis thereof. Accordingly, it is possible to retrieve a recommended route with a higher fuel efficiency by responding also to a fuel efficiency change within the segment and provide a recommended route more suited to a real driving situation. Specifically, as in Case 1 in the recommended route retrieval example, even when no difference is produced between the segments by the use of the average fuel efficiency in the entire segments, by calculating the standard deviation of the time series of the 1-minute average fuel efficiency within the segment for each of the probe vehicles 30 and comparing the calculated standard deviations to each other, it is possible to provide a recommended route with a higher fuel efficiency.

Also, in this embodiment, the standard deviation of the average fuel efficiency in each predetermined time within a predetermined segment is calculated for each of the probe vehicles 30 and, based on the standard deviation, a recommended route extending from a departure place to a destination and including the predetermined segment is retrieved.

As a result, it is possible to calculate the standard deviation of the average fuel efficiency in each predetermined time within the segment for each of the probe vehicles 30 as an index for specifically determining a change in the fuel efficiency within the segment and quantitatively evaluate variations in the average fuel efficiency in each predetermined time within the segment. Accordingly, when the variations in the average fuel efficiency in each predetermined time are small, the frequency of the operation of changing an acceleration opening tends to be lower and the fuel efficiency tends to be higher. Therefore, by evaluating the standard deviation, it is possible to retrieve a recommended route with a higher fuel efficiency. Likewise, when the variations in the average fuel efficiency in each predetermined time are small, the frequency of the operation of changing an acceleration opening decreases to reduce a burden on a driver. Accordingly, by evaluating the standard deviation, it is possible to provide a recommended route which allows easier driving (places a smaller burden on the driver). Further, in the case where the vehicle types of the vehicles having moved, the grades of the engines thereof, the equipment, and the like are greatly different (fuel efficiency performances are greatly different) as in Case 2 of the recommended route retrieval example described above, even when the average fuel efficiency in the entire segment of each of the probe vehicles is used, it is difficult to retrieve a recommended route with a high fuel efficiency. However, by evaluating variations in the 1-minute average fuel efficiency within the segment using the standard deviation, it is possible to provide a recommended route with a higher fuel efficiency irrespective of the types of the individual vehicles 30 or the like.

In addition, in this embodiment, the mean values of the standard deviations of the plurality of probe vehicles 30 having moved across the segments are calculated and, based on the mean values of the standard deviations, a recommended route extending from the departure place to the destination and including the predetermined segment is retrieved. Then, with regard to the predetermined segments forming the plurality of routes each extending from the departure place to the destination, the mean values of the standard deviations are compared to each other and the route including the segment having the minimum mean value of the standard deviations is designated as the recommended route.

By thus averaging the standard deviation in each predetermined time within the segment of each of the probe vehicles 30 with the plurality of probe vehicles 30 each having moved across the segment, an index which allows a segment-by-segment statistic comparison is provided. Accordingly, by comparing the mean values of the standard deviations to each other with regard to each of the segments, the recommended route can be retrieved. Since the route including the segment having the minimum mean value of the standard deviations has smallest variations in the average fuel efficiency in each predetermined time of each of the probe vehicles 30, a recommended route having a higher fuel efficiency and allowing easier driving can be provided.

Also, in the second example of the route retrieval process, when the mean value of the standard deviations in the predetermined segment is calculated, the mean values of the standard deviations of the plurality of probe vehicles 30 each having moved across the predetermined segment in the range of the predetermined time are calculated. Then, on the basis of the mean values, the recommended route extending from the departure place to the destination and including the predetermined segment is retrieved.

As a result, when, e.g., route retrieval based on a real-time road situation is performed, a range of 30 minutes immediately before can be specified or, when route retrieval based on a road situation specific to a day of the week or an hour of the day is performed, the specification of a day of the week or an hour of the day or the like can be performed. This allows a recommended route with higher accuracy and more suited to a real driving situation to be provided.

Also, in the third example of the route retrieval process, when the mean values of the standard deviations in the predetermined segments are calculated, the mean values of those of the standard deviations of the probe vehicles 30 having moved across the predetermined segments which have driven in a normal driving state are calculated. Then, based on the mean values, the recommended route extending from the departure place to the destination and including the predetermined segment is retrieved.

As a result, it is possible to remove the probe vehicle 30 affected by a jam due to an accident, the probe vehicle 30 that had time to be parked in a parking area, a service area, or the like within the segment, and the like and provide a recommended route having higher accuracy.

Note that the predetermined time in the average fuel efficiency in each predetermined time may also be changed depending on the type of a road in the predetermined segment. For example, by setting 1 minute for an express highway or a road only for automobiles and setting 3 minutes for a general road, it is possible to achieve a reduction in the influence of a traffic signal on a general road exerted on variations in average fuel efficiency or the like.

### Second Embodiment

The in-vehicle terminal 10, the information center 20, the probe vehicles 30, and the route retrieval system 1 according to a second embodiment have the same configuration as that of the first embodiment, which is shown by FIG. 1. A description will be given below mainly of a portion different from that of the first embodiment.

The in-vehicle terminal 10 transmits a request for route information including a departure place and a destination to the information center 20 and receives a recommended route and/or route information transmitted from the information center 20 having the function of a route retrieval device.

The main control portion 14 is an information processing terminal including a CPU, a RAM, a ROM, an input/output portion, and the like. The CPU performs various processes in accordance with programs stored in the ROM. For example, the CPU produces an output to the communication processing portion 12 so as to transmit a request for route information including the departure place and the destination specified by a user to the information center 20. The CPU also performs a process for storing the recommended route, the route information or the like each transmitted from the information center 20 and input via the wireless portion 11 and the communication processing portion 12 in the storage portion 15. In addition, the CPU performs a route retrieval process on the basis of the location information of the vehicle input from the GPS reception portion 13 and map data, the route information, or the like stored in the storage portion 15. The CPU also performs the process of generating route guidance information for guiding the vehicle from the departure place to the destination on the basis of the retrieved route, the recommended route transmitted from the information center 20 or the like and outputs the generated route guidance information as an image signal to the display portion 16. Further, the CPU performs the process of generating probe information from the location information of the vehicle input from the GPS reception portion 13, the fuel efficiency information of the vehicle input via the in-vehicle LAN interface 17, or the like under predetermined conditions and outputs, to the communication processing portion 12, the probe information to be transmitted to the center device 20.

The information center 20 provides the service of providing traffic information such as jam information, traffic information, or regulation information generated by the center control portion 22 on the basis of a database of map information, the traffic information, or the like in the center storage portion 23a, traffic information acquired in real time from the outside, or the like. Also, the information center 20 receives, from the probe vehicles 30, the probe information including the various information items acquired by the large number of probe vehicles 30 and produces the database in the center storage portion 23b. Note that the probe information collected by the information center 20 includes the average fuel efficiency in each predetermined time (e.g., 1-minute average fuel efficiency) within the segment acquired by each of the probe vehicles 30. The information center 20 further has the function of the route retrieval device and responds to the route retrieval request from the in-vehicle terminal 10 to provide the service of retrieving a recommended route based on the map information in the center storage portion 23a, the probe information in the center storage portion 23b, or the like and providing the recommended route and the route information to the in-vehicle terminal 10.

The center control portion 22 generates the traffic information such as the jam information, the traffic information, or the regulation information on the basis of a database of the map information, the traffic information, or the like in the center storage portion 23a, the traffic information acquired from the outside, or the like and outputs the generated traffic information to the center communication processing portion 21 so as to transmit the traffic information to the in-vehicle terminal 10. Also, the center control portion 22 performs a process for additionally storing the probe information transmitted from the probe vehicle 30 and input via the center communication processing portion 21, the traffic information received from the outside and input via the center communication processing portion 21, or the like in the database stored in the center storage portion 23a or 23b. The center control portion 22 also performs a route retrieval process on the basis of the route information request including the departure place and the destination transmitted from the in-vehicle terminal 10 and on the basis of the map data in the center storage portion 23a, associated fuel efficiency information described later in the center storage portion 23b, or the like. The center control portion 22 also produces an output to the center communication processing portion 21 so as to transmit the recommended route, the route information, and the like as the result of the route retrieval process to the in-vehicle terminal 10. Further, the center control portion 22 generates a setting signal for setting, for the probe vehicle 30, various conditions (predetermined segment in which the probe information is acquired, information to be acquired, etc.) under which the probe vehicle 30 acquires the probe information and transmits the probe information to the information center 20 and transmits the setting signal to the in-vehicle terminal 10 of the probe vehicle 30 via the center communication processing portion 21.

In this embodiment, the information center 20 retrieves a recommended route in response to the route information request from the in-vehicle terminal 10. However, the information center 20 may also be configured to retrieve a recommended route in response to a route information request from an information processing terminal such as a smart phone or a personal computer. Examples of the information processing terminal also include the in-vehicle terminal 10 (main control portion 14) and the like.

The storage portion 23b stores the probe information, and a database of the probe information is constructed therein. In this embodiment, the fuel efficiency information included in the probe information is stored as fuel efficiency information associated with a predetermined segment and a time unit within the segment which are related to each other. Specifically, the storage portion 23b stores an average fuel efficiency in each predetermined time within the predetermined segment. Note that the predetermined segment is a segment in which the probe information including the average fuel efficiency in each predetermined time is acquired. As described above, the predetermined segment is set by the center control portion 22 of the information center 20 as a segment in which the probe information including the average fuel efficiency in each predetermined time is acquired for each of the probe vehicles 30.

The subsequent process in which the probe vehicle 30 moves, acquires the probe information, especially the average fuel efficiency in each predetermined time within the segment, and transmits the acquired information to the information center is shown in FIG. 2 in the same manner as in the first embodiment. Therefore, a description thereof is omitted.

Next, a description will be given of a route retrieval process performed by the center control portion 22 of the information center 20, especially a fuel efficiency consideration process in which the fuel efficiency information is considered.

The center control portion 22 according to this embodiment performs the route retrieval process shown in the first to third examples of the route retrieval process (FIGS. 3A to 3C) described in the first embodiment. Accordingly, a description thereof is omitted. A description will be given of a route information production process different from that in the first embodiment.

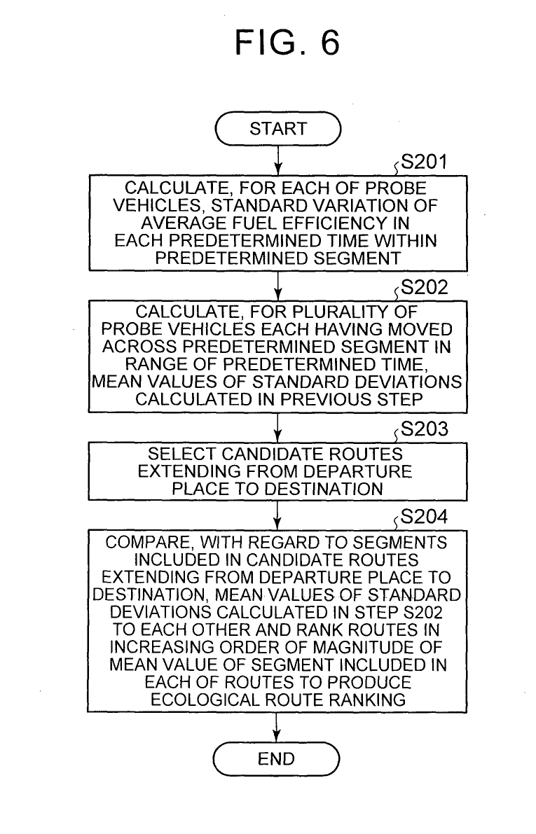

FIG. 6 shows an example of the route information production process performed by the center control portion 22 of the information center 20.

First, in Step S201, for each of the probe vehicles 30, the standard deviation of the average fuel efficiency in each predetermined time within the predetermined segment is calculated.

Next, in Step S202, the mean values of the standard deviations of the plurality of probe vehicles 30 each having moved across the predetermined segment in the range of the predetermined time, which have been calculated in Step S201, are calculated.

Next, in Step S203, for the departure place and the destination each included in the route information request received from the in-vehicle terminal 10, a plurality of candidate routes are retrieved and selected on the basis of the map information, the traffic information, or the like stored in the center storage portion 23a. Note that the route which is not travelable due to construction work, a traffic accident, or the like can be excluded.

Next, in Step S204, with regard to the segments included in the candidate routes selected in Step S203, the mean values of the standard deviations calculated in Step S202 are compared to each other and, by ranking the routes in increasing order of the magnitude of the mean value of the segment included in each of the routes, an ecological route ranking is produced as the route information. Here, FIG. 4 shows the three candidate routes displayed on the display portion 16 of the in-vehicle terminal 10, which include the recommended routes transmitted to the in-vehicle terminal 10 as the result of the route retrieval process according to the second embodiment. For example, an ecological route ranking in which, of the three candidate routes, the recommended route (1) having the calculated mean value of the standard deviations which is the smallest is ranked first, the recommended route (2) having the calculated mean value of the standard deviations which is the second smallest is ranked second, and the predicted route is ranked third is produced and provided to the in-vehicle terminal 10.

Note that this example of the route information production process has a process flow based on the second example of the route retrieval process described above, but may also have a process flow based on the first or third example of the route retrieval process.

Next, FIGS. 5A to 5C show an example in which the route retrieval process is performed by the information center 20 (center control portion 22) in this embodiment. Since the example is the same as in the first embodiment, a description thereof is omitted.

Next, a description will be given of the function of the information center 20 as the route retrieval device according to this embodiment. Note that the description will be given mainly of a portion different from that of the first embodiment.

In this embodiment, in the information center 20 that collects and stores the probe information, the route retrieval process is performed. As a result, the route retrieval can be efficiently performed. Since the information center 20 can perform expansion of resources or the like for the route retrieval process for the center control portion 22, the center storage portions 23a and 23b, or the like more easily than the in-vehicle terminal 10, in terms of an amount of information storage, an ability to perform the route retrieval process, and the like, the route retrieval process may also be performed in the information center 20.

As described above, the information center 20 can also be configured to retrieve a recommended route in response to a route information request from an information processing terminal such as a smart phone or a personal computer. This improves the convenience of a user by allowing the user to perform checking of a recommended route before he or she drives a vehicle or the like.

Also, as described above, in response to the route information request from the information processing terminal, the information center 20 produces, e.g., an ecological ranking or the like as the route information and transmits the ecological ranking or the like to the information processing terminal. This facilitates the use thereof even at an information processing terminal other than the in-vehicle terminal 10 and improves the convenience of the user. This also improves the flexibility of the user by allowing the user to make route determination in association with another information (such as, e.g., a distance or time) or the like.

While the embodiments for carrying out this invention have been described heretofore in detail, this invention is not limited to such specific embodiments. Various changes/modifications can be made in this invention within the scope of the gist of this invention described in the scope of claims.

For example, in each of the first and second embodiments, the retrieval of the recommended route has been performed on the basis of the mean values of the standard deviations of the average fuel efficiencies in each predetermined time within the predetermined segments of the probe vehicles 30 having moved across the predetermined segments. However, the retrieval of the recommended route may also be performed in combination with another index such as the mean values of the average fuel efficiencies in the entire segments.

Also, in each of the first and second embodiments, the description has been given of the retrieval of the recommended route in which the fuel efficiency is considered. However, the retrieval of the recommended route can also be performed in combination with route retrieval based on another criterion. For example, the retrieval of the recommended route may also be performed in combination with time priority retrieval for retrieving a route having a shortest driving time from a departure place to a destination, distance priority retrieval for retrieving a route having a shortest driving distance from a departure place to a destination, or the like.

1. A route retrieval device, comprising:
a storage portion configured to store fuel efficiency information of a probe vehicle having passed through a segment in each predetermined time within the segment, the fuel efficiency information associated with a plurality of predetermined segments for each of the plurality of predetermined segments; and
a main control portion configured to retrieve a recommended route extending from a departure place to a destination on the basis of fuel efficiency change of each probe vehicle having passed through the segment, the fuel efficiency change determined by the fuel efficiency information in each predetermined time, the recommended route including the segment included in the plurality of predetermined segments.

2. The route retrieval device according to claim 1, wherein
the fuel efficiency information in each predetermined time is an average fuel efficiency in each predetermined time within the segment, and
the main control portion calculates, for each of the probe vehicles having passed through the segment, a standard deviation of the average fuel efficiency in each predetermined time within the segment and retrieves the recommended route on the basis of the standard deviation.

3. The route retrieval device according to claim 2, wherein
the main control portion calculates mean values of the standard deviations of the plurality of probe vehicles that have each moved across the segment in a range of a predetermined time and retrieves the recommended route on the basis of the mean values of the standard deviations.

4. The route retrieval device according to claim 3, wherein
the main control portion compares, with regard to the respective segments included in a plurality of routes each extending from the departure place to the destination, the mean values of the standard deviations to each other and designates the route including the segment having the minimum mean value of the standard deviations as the recommended route.

5. The route retrieval device according to claim 1, further comprising:
a communication portion configured to communicate with an information center that collects a probe information from the plurality of probe vehicles, wherein
the main control portion acquires the probe information from the information center via the communication portion.

6. A route retrieval system, comprising:
an information center including a center control portion including the route retrieval device according to claim 1; and
an information processing terminal, wherein
the information processing terminal transmits, to the information center, a request for route information including a departure place and a destination each specified by a user, and
the information center uses the route retrieval device to retrieve a recommended route extending from the departure place to the destination on the basis of the request for the route information.

7. The route retrieval system according to claim 6, wherein
the information processing terminal is a terminal mounted in a vehicle.
